(19) United States
(12) Patent Application Publication
(10) Pub. No.: US 2025/0269313 A1
(43) Pub. Date: Aug. 28, 2025

(54) HONEYCOMB STRUCTURE

(71) Applicant: NGK INSULATORS, LTD., Nagoya-City (JP)

(72) Inventors: Kazuya MORI, Anjo-Shi (JP); Sho INOTSUME, Miyoshi-Shi (JP)

(73) Assignee: NGK INSULATORS, LTD., Nagoya-City (JP)

(21) Appl. No.: 19/055,703

(22) Filed: Feb. 18, 2025

(30) Foreign Application Priority Data
Feb. 22, 2024 (JP) 2024-025913

(51) Int. Cl. B01D 46/24

(52) U.S. Cl. CPC B01D 46/249; B01D 46/2429; B01D 46/24494; B01D 46/2474; B01D 46/2482; B01D 46/2484; B01D 2279/30

(57) ABSTRACT

A pillar-shaped honeycomb structure, wherein a cell density based on a total number of a plurality of inlet cells and a plurality of outlet cells is 22 to 70 cells/cm², wherein a thickness of each of partition walls is in a range of 0.15 mm or more and 0.38 mm or less, wherein an opening ratio at an inlet end surface is 44% or more, and wherein assuming a total surface area of all partition walls partitioning the plurality of inlet cells excluding the inlet cells adjacent to an outer peripheral side wall is S₁, and a total surface area of all partition walls sandwiched between adjacent inlet cells among the plurality of inlet cells excluding the inlet cells adjacent to the outer peripheral side wall is S₂, 33%≤S₂/S₁≤75% is satisfied.

### CROSS REFERENCE TO RELATED APPLICATIONS

The present invention claims the benefit of priority to Japanese Patent Application No. 2024-25913 filed on Feb. 22, 2024 with the Japanese Patent Office, the entire contents of which are incorporated herein by reference in its entirety.

### FIELD OF THE INVENTION

The present invention is related to a honeycomb structure.

### BACKGROUND OF THE INVENTION

Diesel engines have better thermal efficiency than gasoline engines, but they generate particulate matter (PM) such as soot and ash due to diffusive combustion. This particulate matter is known to be carcinogenic, so it is essential to prevent its release into the atmosphere. For this reason, in addition to the conventional weight-based quantity restrictions, strict PM count restrictions are now being imposed, mainly in Europe.

However, there are limits to how much PM emissions can be reduced by improving combustion, and the only effective measure currently available is to install a filter called a DPF (Diesel Particulate Filter) in the exhaust. As this filter, a wall-flow type filter designed such that exhaust gas passes through porous partition walls is effective. Specifically, the wall-flow type filter has a large number of inlet cells and a large number of outlet cells adjacent to each other via porous partition walls, and can be configured with a honeycomb structure that captures PM while the exhaust gas passes through the partition walls.

Wall-flow type filters comprised of honeycomb structures have a problem in that PM accumulates in the filter as the operating time increases, resulting in increased pressure loss. For this reason, an extra fuel is injected to such filters every time a certain amount of PM accumulates, thereby increasing the exhaust gas temperature and burning the soot (filter regeneration), and thereby reducing the pressure loss. In addition, since ash does not burn even at high temperatures, trucks and off-road vehicles, which travel longer distances (that is, the filter operating time is longer) than passenger cars, require regular cleaning of the honeycomb structure to remove the ash that accumulates in the filter and to reduce the pressure loss. If the pressure loss due to PM accumulation increases quickly, filter regeneration and cleaning treatment will need to be performed more frequently, resulting in increased fuel consumption and maintenance costs. Accordingly, efforts have been made to reduce the pressure loss due to PM accumulation by modifying the arrangement and size of the inlet cells and the outlet cells (Patent Literature 1 and Patent Literature 2).

### PRIOR ART

### Patent Literature

[Patent Literature 1] WO 2019/104057 A1

[Patent Literature 2] WO 2013/187444 A1

### SUMMARY OF THE INVENTION

Conventionally, the timing of filter regeneration or cleaning treatment has been determined by measuring the pressure loss between the inlet and outlet of the filter using a pressure sensor. However, if the pressure loss remains low after a large amount of PM has accumulated in the filter, when filter regeneration control is performed using a pressure sensor, it becomes increasingly difficult to predict the amount of PM accumulation due to the pressure loss, resulting in excessive PM accumulation and possible damage to the filter. Therefore, it is desirable to reduce the frequency of filter regeneration and cleaning treatment and thereby reduce maintenance costs by minimizing the pressure loss after PM accumulation as much as possible, while at the same time making it easier for the pressure sensor to detect the amount of PM accumulation suitable for filter regeneration and cleaning treatment by increasing the amount of change in pressure loss (pressure loss gradient) corresponding to the amount of PM accumulated.

The present invention has been made in consideration of the above-mentioned circumstances, and in one embodiment, an object is to provide a honeycomb structure that is able to keep maintenance costs low and is able to easily detect when maintenance is required using a pressure sensor based on the amount of PM accumulation.

The present inventors have conducted extensive research to solve the above problem and have completed the present invention, which is exemplified as below.

### [Aspect 1]

A pillar-shaped honeycomb structure, comprising:
an outer peripheral side wall;
a plurality of inlet cells arranged on an inner peripheral side of the outer peripheral side wall, extending from an inlet end surface to an outlet end surface, having an opening at the inlet end surface, and having a sealing portion at the outlet end surface; and
a plurality of outlet cells arranged on the inner peripheral side of the outer peripheral side wall, extending from the inlet end surface to the outlet end surface, having a sealing portion at the inlet end surface, and having an opening at the outlet end surface;
wherein each of the plurality of inlet cells and the plurality of outlet cells is adjacent to at least one of the plurality of inlet cells and the plurality of outlet cells with each of partition walls interposed therebetween,
wherein a cell density based on a total number of the plurality of inlet cells and the plurality of outlet cells is 22 to 70 cells/cm²,
wherein a thickness of each of the partition walls is in a range of 0.15 mm or more and 0.38 mm or less,
wherein an opening ratio at the inlet end surface is 44% or more, and
wherein assuming a total surface area of all the partition walls partitioning the plurality of inlet cells excluding the inlet cells adjacent to the outer peripheral side wall is S₁, and a total surface area of all the partition walls sandwiched between adjacent inlet cells among the plurality of inlet cells excluding the inlet cells adjacent to the outer peripheral side wall is S₂, 33%≤S₂/S₁≤75% is satisfied.

### [Aspect 2]

The honeycomb structure according to aspect 1, wherein an opening area of each of the plurality of inlet cells are all the same except for those adjacent to the outer peripheral side wall.

### [Aspect 3]

The honeycomb structure according to aspect 1 or 2, wherein an opening area of each of the plurality of inlet cells and the plurality of outlet cells are all the same except for those adjacent to the outer peripheral side wall.

### [Aspect 4]

The honeycomb structure according to any one of aspects 1 to 3, wherein an opening shape of each of the plurality of inlet cells is square except for those adjacent to the outer peripheral side wall.

### [Aspect 5]

The honeycomb structure according to any one of aspects 1 to 4, wherein an opening shape of each of the plurality of inlet cells and the plurality of outlet cells is all square except for those adjacent to the outer peripheral side wall.

### [Aspect 6]

The honeycomb structure according to any one of aspects 1 to 5, wherein an opening shape and an opening area of each of the plurality of inlet cells are all the same except for the one adjacent to the outer peripheral side wall.

### [Aspect 7]

The honeycomb structure according to aspect 4, wherein a length of one side of the square is 0.90 mm or more and 1.90 mm or less.

### [Aspect 8]

The honeycomb structure according to aspect 5, wherein a length of one side of the square is 0.90 mm or more and 1.90 mm or less.

### [Aspect 9]

The honeycomb structure according to any one of aspects 1 to 8, wherein none of the plurality of outlet cells are adjacent to each other.

### [Aspect 10]

The honeycomb structure according to any one of aspects 1 to 9, wherein the partition walls have an average linear expansion coefficient from room temperature to 800° C. in a direction in which the inlet cells and the outlet cells extend of 1.0×⁻⁶/° C. or less.

### [Aspect 11]

The honeycomb structure according to any one of aspects 1 to 10, wherein the partition walls comprise cordierite.

### [Aspect 12]

The honeycomb structure according to any one of aspects 1 to 11, wherein the thickness of each of the partition walls is in a range of 0.18 mm or more and 0.30 mm or less.

### [Aspect 13]

The honeycomb structure according to any one of aspects 1 to 12, wherein the cell density based on the total number of the plurality of inlet cells and the plurality of outlet cells is in a range of 26 to 62 cells/cm².

### [Aspect 14]

The honeycomb structure according to any one of aspects 1 to 13, wherein at least one of the plurality of inlet cells is not adjacent to any of the plurality of outlet cells.

### [Aspect 15]

The honeycomb structure according to any one of aspects 1 to 14, wherein at least one of the plurality of outlet cells is adjacent to only an inlet cell.

### [Aspect 16]

The honeycomb structure according to any one of aspects 1 to 15, wherein
a ratio of a number of the plurality of inlet cells to a number of the plurality of outlet cells is 1.5 to 2.0, and the cell density based on the total number of the plurality of inlet cells and the plurality of outlet cells is in a range of 47 to 62 cells/cm²; or
a ratio of a number of the plurality of inlet cells to the number of the plurality of outlet cells is 3.0 to 4.0, and the cell density based on the total number of the plurality of inlet cells and the plurality of outlet cells is in a range of 28 to 43 cells/cm².

By using the honeycomb structure according to one embodiment of the present invention as an exhaust gas filter, the pressure loss after accumulation of PM can be minimized as much as possible, thereby reducing the frequency of filter regeneration and cleaning treatment, and meanwhile, by increasing the amount of change in pressure loss (pressure loss gradient) corresponding to the amount of accumulated PM, it is possible to make it easier for the pressure sensor to detect the amount of PM accumulation suitable for filter regeneration or cleaning treatment. This makes it possible to obtain a filter that is able to keep maintenance costs low and is able to easily detect when maintenance is required using a pressure sensor based on the amount of PM accumulation. Therefore, it is possible to reduce the risk of the filter being damaged due to excessive accumulation of PM. In addition, this effect can be achieved without sacrificing thermal shock resistance. Therefore, according to one embodiment of the present invention, it can be said that a honeycomb structure that is extremely excellent in practical use can be provided.

### BRIEF DESCRIPTION OF THE DRAWINGS

FIG. 1 is a perspective view showing a wall-flow type honeycomb structure.

FIG. 2 is a schematic cross-sectional view of a wall-flow type honeycomb structure when observed from a cross section parallel to the direction in which the cells extend.

FIG. 3 is a schematic partial enlarged view of partition walls of a honeycomb structure when observed from a cross section perpendicular to the direction in which the cells extend.

FIG. 4 is an explanatory diagram showing a schematic example of a method for forming sealing portions using a squeegee method.

FIG. 5A is a schematic diagram showing a cell structure and sealing pattern of “Variation 1SQ”.

FIG. 5B is a schematic diagram showing a cell structure and sealing pattern of “Variation 2SQ”.

FIG. 5C is a schematic diagram showing a cell structure and sealing pattern of “Variation 3SQ”.

FIG. 5D is a schematic diagram showing a cell structure and sealing pattern of “Variation 4SQ”.

FIG. 5E is a schematic diagram showing a cell structure and sealing pattern of “Variation 5SQ”.

FIG. 5F is a schematic diagram showing a cell structure and sealing pattern of “Variation 6SQ”.

FIG. 5G is a schematic diagram showing a cell structure and sealing pattern of “Variation 7SQ”.

FIG. 5H is a schematic diagram showing a cell structure and sealing pattern of “HEX”.

FIG. 5I is a schematic diagram showing a cell structure and sealing pattern of “Normal HAC”.

FIG. 5J is a schematic diagram showing a cell structure and sealing pattern of “Variation 1 HAC”.

### DETAILED DESCRIPTION OF THE INVENTION

Hereinafter, embodiments of the present invention will now be described in detail with reference to the drawings. It should be understood that the present invention is not intended to be limited to the following embodiments, and any change, improvement or the like of the design may be appropriately added based on ordinary knowledge of those skilled in the art without departing from the spirit of the present invention.

### 1. Honeycomb Structure

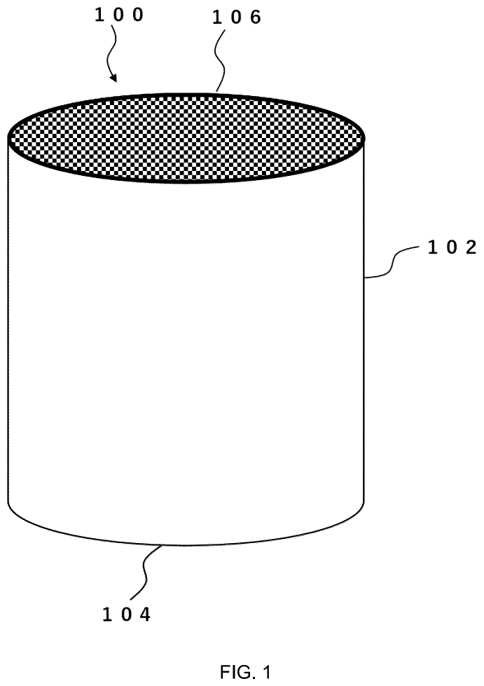

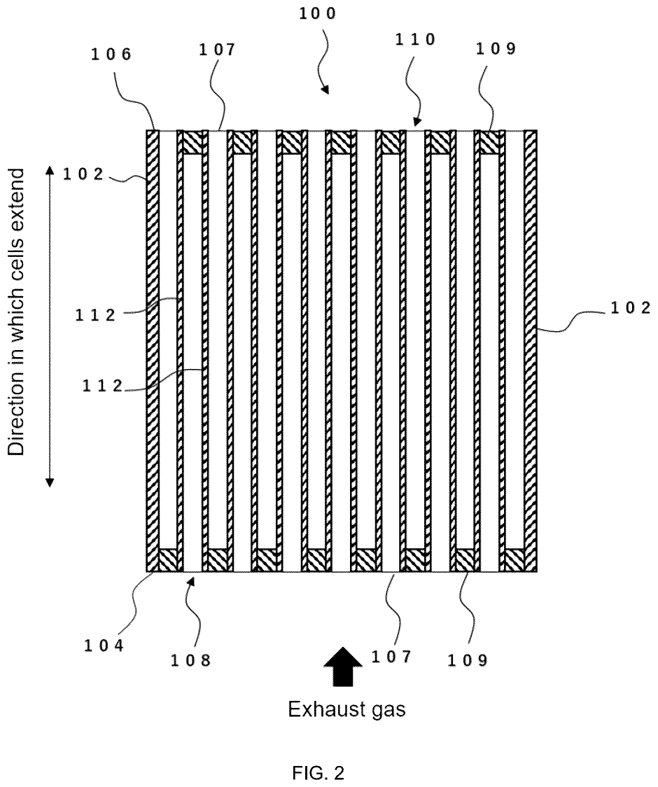

FIGS. 1 and 2 are a schematic perspective view and a cross-sectional view, respectively, of a pillar-shaped honeycomb structure 100 that can be used as a wall-flow type exhaust gas filter for automobiles. The honeycomb structure 100 comprises: an outer peripheral side wall 102; a plurality of inlet cells 108 arranged on the inner peripheral side of the outer peripheral side wall 102, extending from an inlet end surface 104 to an outlet end surface 106 in parallel, having an opening 107 at the inlet end surface 104, and having a sealing portion 109 at the outlet end surface 106; and a plurality of outlet cells 110 arranged on the inner peripheral side of the outer peripheral side wall 102, extending from the inlet end surface 104 to the outlet end surface 106 in parallel, having a sealing portion 109 at the inlet end surface, and having an opening 107 at the outlet end surface 106.

In this honeycomb structure 100, the plurality of inlet cells 108 and the plurality of outlet cells 110 are each adjacent to at least one of the plurality of inlet cells 108 and the plurality of outlet cells 110 with each of partition walls 112 interposed therebetween. When the inlet cell 108 and the outlet cell 110 are adjacent to each other with the partition wall 112 interposed therebetween, the surface of the partition wall 112 (hereinafter, the partition wall 112 separating the inlet cell 108 and the outlet cell 110 is referred to as “partition wall A”) contributes to filtration. For example, when exhaust gas containing particulate matter such as soot is supplied to the upstream inlet end surface 104 of the honeycomb structure 100, the exhaust gas is introduced into the inlet cell 108 and travels downstream within the inlet cells 108. Since the inlet cell 108 is sealed at the outlet end surface 106 on the downstream side, the exhaust gas passes through the partition wall A located between the adjacent inlet cell 108 and outlet cell 110 and flows into the outlet cell 110. Since the particulate matter cannot pass through the partition wall A, it is captured and deposited in the inlet cell 108. After the particulate matter has been removed, the clean exhaust gas that has flowed into the outlet cell 110 advances downstream within the outlet cell 110 and flows out from the outlet end surface 106 on the downstream side.

On the other hand, when the inlet cells 108 are adjacent to each other with the partition wall 112 interposed therebetween, the surface of the partition wall 112 (hereinafter, the partition wall 112 separating the inlet cells 108 is referred to as “partition B”) does not contribute to filtration. When the outlet cells 110 are adjacent to each other with the partition wall 112 interposed therebetween, the surface of the partition wall 112 (hereinafter, the partition wall 112 separating the outlet cells 110 is referred to as “partition C”) does not contribute to filtration.

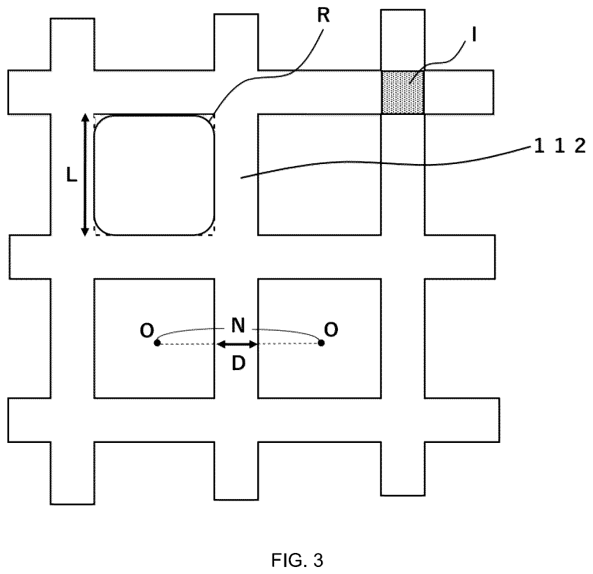

In addition, “two cells are adjacent to each other with the partition wall interposed therebetween” means that when the partition walls of the honeycomb structure are observed from a cross section perpendicular to the direction in which the cells extend, the two cells are adjacent to each other with opposing wall surfaces of a single partition wall between them, and does not include the case where the two cells are adjacent to each other with an intersection portion I of the partition walls between them (see FIG. 3).

The higher the surface area ratio of partition wall A is, the lower the pressure loss upon PM accumulation and the gentler the pressure loss gradient is. The higher the surface area ratio of partition wall B is, the higher the pressure loss upon PM accumulation and the steeper the pressure loss gradient is. Therefore, since the balance between partition wall A and partition wall B determines the magnitude of the initial pressure loss and the pressure loss gradient, it is desirable to set them appropriately. Specifically, assuming the total surface area of all the partition walls 112 partitioning the plurality of inlet cells 108 excluding the inlet cells 108 adjacent to the outer peripheral side wall 102 is S₁, and the total surface area of all the partition walls 112 sandwiched between adjacent inlet cells 108 among the plurality of inlet cells 108 excluding the inlet cells 108 adjacent to the outer peripheral side wall 102 is S₂, it is preferable that 33%≤S₂/S₁≤75% be satisfied, it is more preferable that 50%≤S₂/S₁≤71% be satisfied, and it is even more preferable that 60%≤S₂/S₁≤67% be satisfied.

For example, if the opening shape of each inlet cell is square with a side length L, assuming the length of each inlet cell in the direction in which the cell extends (the length from the inlet end surface to the outlet end surface minus the length of the sealing portion) is H, and the total number of inlet cells excluding the inlet cells adjacent to the outer peripheral side wall is C_{A}, then S₁ can be expressed as S₁=L×H×4×C_{A}. Assuming the total number of partition walls interposed between adjacent inlet cells, excluding the inlet cells adjacent to each other on the outer peripheral side wall, is W_{A}, then S₂ is expressed as S₂=L×H×2×W_{A}.

In a preferred embodiment, at least one of the plurality of input cells 108 is not adjacent to any of the plurality of output cells 110. Since such an inlet cell 108 is partitioned only by the partition wall B, the area ratio of the partition wall B can be effectively increased, and that of the partition wall A is relatively reduced, which contributes to an increase in the pressure loss gradient. For example, among the plurality of inlet cells 108 excluding the inlet cells 108 adjacent to the outer peripheral sidewall 102, it is preferable that 10 to 35% of the number of the inlet cells 108 be not adjacent to any of the plurality of outlet cells 110, and it is more preferable that 20 and 35% of the number of the input cells 108 be not adjacent to any of the plurality of output cells 110.

In a preferred embodiment, at least one of the plurality of outlet cells 110 is adjacent only to an inlet cell 108 (that is, adjacent neither to the outlet cell 110 nor to the outer peripheral side wall 102). This is because the filtration function is achieved by the outlet cells 110 being adjacent to the inlet cells 108. It is preferable that none of the plurality of outlet cells 110 are adjacent to each other.

In order to reduce the area of the partition walls A while maintaining the frequency of the cleaning treatment, it is preferable that the cell density of the honeycomb structure 100 be set to a relatively low value. Specifically, the cell density (the number of cells per unit cross-sectional area) based on the total number of the plurality of inlet cells 108 and the plurality of outlet cells 110 is preferably 22 to 70 cells/cm², and more preferably 26 to 62 cells/cm², in consideration of the balance with the suppression of pressure loss upon PM accumulation. Here, the cell density is calculated by dividing the total number of cells (including the sealed cells, the outlet cells 110 adjacent to the outer peripheral side wall 102, and the inlet cells 108 adjacent to the outer peripheral side wall 102) by the area of one end surface of the honeycomb structure excluding the outer peripheral side wall.

From the viewpoint of increasing the pressure loss gradient while suppressing an increase in pressure loss, the preferable range of the cell density also varies depending on the ratio of the number of the plurality of inlet cells 108 to the number of the plurality of outlet cells 110. Specifically, when the ratio (I/O) of the number of the plurality of inlet cells 108 excluding the inlet cells 108 adjacent to the outer peripheral side wall 102 to the number of the plurality of outlet cells 110 excluding the outlet cells 110 adjacent to the outer peripheral side wall 102 is 1.5 to 2.0, it is preferable that the cell density based on the total number of the plurality of inlet cells 108 and the plurality of outlet cells 110 be in the range of 47 to 62 cells/cm². When the ratio (I/O) of the number of the plurality of inlet cells 108 excluding the inlet cells 108 adjacent to the outer peripheral side wall 102 to the number of the plurality of outlet cells 110 excluding the outlet cells 110 adjacent to the outer peripheral side wall 102 is 3.0 to 4.0, it is preferable that the cell density based on the total number of the plurality of inlet cells 108 and the plurality of outlet cells 110 be in the range of 28 to 43 cells/cm².

From the viewpoint of ensuring the strength of the honeycomb structure, the thickness of each of the partition walls in the honeycomb structure is preferably 0.15 mm or more, more preferably 0.18 mm or more, and further preferably 0.21 mm or more. In addition, from the viewpoint of suppressing pressure loss upon PM accumulation, the thickness of each of the partition walls is preferably 0.38 mm or less, more preferably 0.31 mm or less, even more preferably 0.30 mm or less, and still more preferably 0.27 mm or less. Therefore, the thickness of each of the partition walls is, for example, preferably 0.15 to 0.38 mm, more preferably 0.18 to 0.31 mm, even more preferably 0.18 to 0.30 mm, and still more preferably 0.21 to 0.27 mm.

FIG. 3 shows a schematic partial enlarged view of the partition walls 112 of the honeycomb structure 100 observed in a cross section perpendicular to the direction in which the cells extend. The thickness of the partition wall refers to a crossing length D of a line segment N that crosses the partition wall when the centers of gravity O of adjacent cells are connected by this line segment in a cross-section orthogonal to the direction in which the cells extend (the height direction of the honeycomb structure).

From the viewpoint of suppressing pressure loss upon PM accumulation, the opening ratio at the inlet end surface 104 is preferably 44% or more, more preferably 50% or more, and even more preferably 54% or more. On the other hand, from the viewpoint of ensuring an outlet side flow paths and suppressing initial pressure loss, the opening ratio at the inlet end surface 104 is preferably 60% or less, more preferably 58% or less, and even more preferably 56% or less. Therefore, the opening ratio at the inlet end surface 104 is, for example, preferably 44 to 60%, more preferably 50 to 58%, and even more preferably 54 to 56%.

As used herein, the opening ratio at the inlet end surface 104 is a value obtained by dividing the total opening area of the inlet cells 108 at the inlet end surface 104 of the honeycomb structure 100 by the area of the inlet end surface 104 (the total area of the partition walls 112, the inlet cells 108, and the outlet cells 110 excluding the outer peripheral side wall 102).

From the viewpoint of suppressing the variation in flow rate among the inlet cells, it is preferable that the opening areas of the inlet cells 108 be all the same except for those adjacent to the outer peripheral side wall 102. Here, “the same” is a concept that includes being substantially the same. For example, when the area Amin of the inlet cell 108 with the smallest opening area and the area Amax of the inlet cell 108 with the largest opening area among the plurality of inlet cells 108 excluding the inlet cells 108 adjacent to the outer peripheral side wall 102 satisfy the relationship of 0.90≤Aₘᵢₙ/Aₘₐₓ≤1.00, the opening areas are substantially the same. It is preferable that the relationship of 0.95≤Aₘᵢₙ/Aₘₐₓ≤1.00 be satisfied.

Furthermore, it is more preferable that the opening shape and opening area of each of the plurality of inlet cells 108 be all the same except for those adjacent to the outer peripheral side wall 102. This is because having the same opening shape as well as the same opening area provides the advantage of suppressing variation in flow rate among the inlet cells. Here, “the same” is a concept that includes being substantially the same, such as having the same opening shape in terms of design.

Furthermore, it is more preferable that the opening areas of the plurality of inlet cells 108 and the plurality of outlet cells 110 be all the same except for those adjacent to the outer peripheral side wall. This is because if the opening areas of the inlet cell 108 and the outlet cell 110 are the same, the difference in flow rate between the inlet cell 108 and the outlet cell 110 becomes small, which is advantageous in that pressure loss is suppressed. Here, “the same” is a concept that includes being substantially the same. For example, when the area Bₘᵢₙ of the outlet cell 110 with the smallest opening area and the area Bₘₐₓ of the outlet cell 110 with the largest opening area among the plurality of outlet cells 110 excluding the outlet cells 110 adjacent to the outer peripheral side wall 102 satisfy the relationship of 0.90≤Bₘᵢₙ/Bₘₐₓ≤1.00, the opening areas are substantially the same. It is preferable that the relationship of 0.95≤Bₘᵢₙ/Bₘₐₓ≤1.00 is satisfied.

The opening shapes of the inlet cell 108 and the outlet cell 110 are not particularly limited, and in the cross section orthogonal to the direction in which the cells of the honeycomb structure extend, the opening shape can be a polygon (a quadrangle (rectangle, square), pentagon, hexagon, heptagon, octagon, and the like), a round shape (a circle, an ellipse, an oval, an egg shape, an elongated circular shape, and the like), and the like. These shapes may be adopted alone or in combination of two or more. When the opening shape of the inlet cell 108 and the outlet cell 110 is polygonal, the corners may be rounded. As used herein, even if the corners are rounded, they are treated as polygonal.

From the viewpoint of suppressing clogging with soot and unburned components, it is preferable that the opening shape of each of the plurality of inlet cells 108 be all square, except for the one adjacent to the outer peripheral side wall 102. Furthermore, it is more preferable that the opening shapes of each of the plurality of inlet cells 108 and the plurality of outlet cells 110 be all square except for those adjacent to the outer peripheral side wall 102. The length of one side of the square is preferably 0.90 mm or more and 1.90 mm or less, and more preferably 1.00 mm or more and 1.70 mm or less. In addition, when the corners of a square are rounded, the length of one side of the square having the rounded chamfered portion R is regarded as the length L of one side of the square when it is assumed that the corners are not rounded (see FIG. 3).

The shape of the end surface of the honeycomb structure 100 is not limited, and may be, for example, a round shape such as a circle, an ellipse, a racetrack shape, or a long circle shape, a polygonal shape such as a triangle or a quadrangle, or other irregular shape. The illustrated honeycomb structure 100 has a circular shape of the end surface and is cylindrical as a whole.

There is no particular limitation on the height of the honeycomb structure (the length from the inlet end surface to the outlet end surface), and it may be appropriately set depending on the application and required performance. The height of the honeycomb structure may be, for example, 40 to 450 mm. There is no particular limitation on the relationship between the height of the honeycomb structure and the maximum diameter of each end surface (the maximum length of the diameters passing through the center of gravity of each end surface of the honeycomb structure). Therefore, the height of the honeycomb structure may be longer than the maximum diameter of each end surface, or the height of the honeycomb structure may be shorter than the maximum diameter of each end surface.

From the viewpoint of reducing pressure loss, the partition walls preferably have a lower limit of the average porosity of 41% or more, more preferably 52% or more. In addition, from the viewpoint of increasing the mechanical strength of the honeycomb structure, the partition walls preferably have an upper limit of the average porosity of 65% or less, and more preferably 60% or less. Therefore, the partition walls preferably have an average porosity of, for example, 41 to 65%, and more preferably 52 to 60%. As used herein, the porosity is measured by the mercury porosimetry in accordance with JIS R1655: 2003. In addition, the average porosity is determined by taking partition wall samples (0.3 g each) from six locations of the honeycomb structure without bias, and measuring the porosity of each sample, and the average value is regarded as the measured value.

From the viewpoint of obtaining excellent thermal shock resistance, the average linear expansion coefficient of the partition walls from room temperature to 800° C. in the extension direction of the inlet cells 108 and the outlet cells 110 is preferably 1.0×10⁻⁶/° C. or less, more preferably 0.8×10⁻⁶/° C. or less, and even more preferably 0.6×10⁻⁶/° C. or less. No lower limit is set for the average linear expansion coefficient, but taking into consideration ease of manufacture, the average linear expansion coefficient is preferably 0.8×10⁻⁶/° C. to 1.0×⁻⁶/° C., more preferably 0.6×10⁻⁶/° C. to 0.8×10⁻⁶/° C., and even more preferably 0.4×10⁻⁶/° C. to 0.6×10⁻⁶/° C. The average linear expansion coefficient is measured according to JIS R1618: 2002. The average linear expansion coefficient of the partition walls can be controlled by the material and porosity that constitute the partition walls.

From the viewpoint of obtaining excellent thermal shock resistance, at least the partition walls of the honeycomb structure, preferably the outer peripheral side wall and the partition walls, more preferably the outer peripheral side wall, the partition walls and the sealing portions contain cordierite (2MgO·2Al₂O₃·5SiO₂) and/or silicon carbide (SiC).

When the honeycomb structure comprises cordierite as its main component, the lower limit of the cordierite content of the partition walls of the honeycomb structure, preferably the outer peripheral side wall and partition walls, more preferably the outer peripheral side wall, the partition walls and the sealing portions, is preferably 90% by mass or more, more preferably 91% by mass or more, and even more preferably 92% by mass or more. Although no upper limit is particularly set, from the viewpoint of modifying the characteristics of the honeycomb structure by adding other ceramics, the upper limit of the cordierite content of the partition walls of the honeycomb structure, preferably the outer peripheral side wall and the partition walls, more preferably the outer peripheral side wall, the partition walls and the sealing portions, is preferably 96 mass % or less, more preferably 95 mass % or less, and even more preferably 94 mass % or less. Therefore, when the honeycomb structure comprises cordierite as a main component, the partition walls of the honeycomb structure, preferably the outer peripheral side wall and the partition walls, more preferably the outer peripheral side wall, the partition walls and the sealing portions have a cordierite content of, for example, preferably 90 to 96 mass %, more preferably 91 to 95 mass %, and even more preferably 92 to 94 mass %.

The cordierite content can be measured by X-ray diffraction. Specifically, an X-ray diffraction apparatus using Cu Kα radiation (for example, X'pert PRO apparatus manufactured by PANalytical) is used to perform X-ray analysis measurement in the range of 2θ=8 to 100° by X-ray diffraction on a sample of the outer peripheral side wall, the partition wall, or the sealing portion, and analysis is performed using the Rietveld analysis program RIETAN to measure the crystalline phase ratio of cordierite, which is regarded as the cordierite content.

When the honeycomb structure comprises silicon carbide as its main component, the lower limit of the silicon carbide content of the partition walls of the honeycomb structure, preferably the outer peripheral side wall and the partition walls, more preferably the outer peripheral side wall, the partition walls and the sealing portions, is preferably 66% by mass or more, more preferably 67% by mass or more, and even more preferably 68% by mass or more. Although no upper limit is particularly set, from the viewpoint of modifying the characteristics of the honeycomb structure by adding other ceramics, the upper limit of the silicon carbide content of the partition walls of the honeycomb structure, preferably the outer peripheral side wall and the partition walls, more preferably the outer peripheral side wall, the partition walls and the sealing portions, is preferably 76 mass % or less, more preferably 75 mass % or less, and even more preferably 74 mass % or less. Therefore, when the honeycomb structure comprises silicon carbide as its main component, the partition walls of the honeycomb structure, preferably the outer peripheral side wall and the partition walls, more preferably the outer peripheral side wall, the partition walls and the sealing portions, have a silicon carbide content of, for example, preferably 66 to 76% by mass, more preferably 67 to 75% by mass, and even more preferably 68 to 74% by mass.

The silicon carbide content can be measured by X-ray diffraction. Specifically, an X-ray diffraction apparatus using Cu Kα radiation (for example, X'pert PRO apparatus manufactured by PANalytical) is used to perform X-ray analysis measurement in the range of 2θ=8 to 100° by X-ray diffraction method on a sample of the outer peripheral side wall, the partition wall or the sealing portion, and analysis is performed using the Rietveld analysis program RIETAN to measure the crystalline phase ratio of metallic Si in the sample (=metallic Si content (% by mass)). Next, the oxygen O content (% by mass) in the sample is quantified by an inert gas fusion method. The SiO₂ content (% by mass) in the sample is calculated by multiplying the oxygen O content by 60/32. Finally, the silicon carbide content is calculated according to the formula: silicon carbide content (% by mass)=100−metallic Si content (% by mass)−SiO₂ content (% by mass).

The outer peripheral side wall, the partition walls and the sealing portions of the honeycomb structure may contain ceramics other than cordierite and SiC. Other ceramics include, for example, mullite, zirconium phosphate, aluminum titanate, silicon-silicon carbide composites (e.g., Si-bonded SiC), cordierite-silicon carbide composites, zirconia, spinel, indialite, sapphirine, corundum, titania, silicon nitride, and ceria. Further, for these other ceramics, one type may be contained alone, or two or more types may be contained in combination.

In one embodiment, the sealing portions at both the inlet end surface and the outlet end surface have an average depth of 2 to 8 mm. When the average depth of the sealing portions is 2 mm or more, the strength of the sealing portions can be ensured. The average depth of the sealing portions is preferably 3 mm or more. In addition, by making the average depth of the sealing portions 8 mm or less, it is possible to prevent the area of the partition walls that capture particulate matter in the cells from becoming small. The average depth of the sealing portions is preferably 7 mm or less. The depth of the sealing portions in the direction in which the cells extend is measured at 20 random locations on each end surface, and the average value is regarded as the average depth of the sealing portions on each end surface. The depth of each sealing portion means the length in the direction in which the cells extend from the position of the inlet end surface or outlet end surface where the sealing portion is formed to the deepest position where the sealing portion exists.

The honeycomb structure can also be used as a catalyst carrier. A catalyst can be supported on the surface of the partition walls according to the purpose. Examples of the catalyst include, but are not limited to, oxidation catalyst (DOC) for increasing the exhaust gas temperature by oxidizing and burning hydrocarbons (HC) and carbon monoxide (CO), PM combustion catalysts for assisting in the combustion of PM such as soot, SCR catalysts and NSR catalysts for removing nitrogen oxides (NOx), and three-way catalysts capable of simultaneously removing hydrocarbons (HC), carbon monoxide (CO), and nitrogen oxides (NOx). The catalyst may appropriately contain, for example, precious metals (Pt, Pd, Rh, and the like.), alkali metals (Li, Na, K, Cs, and the like.), alkaline earth metals (Mg, Ca, Ba, Sr, and the like.), rare earths (Ce, Sm, Gd, Nd, Y, La, Pr, and the like.), transition metals (Mn, Fe, Co, Ni, Cu, Zn, Sc, Ti, Zr, V, Cr, and the like.), and the like.

The honeycomb structure may be a honeycomb joined body having a plurality of honeycomb segments and a joining layer joining the outer peripheral surfaces of the plurality of honeycomb segments together. By using the honeycomb joined body, it is possible to increase the total cross-sectional area of the cells, which is important for ensuring the flow rate of air, while suppressing the occurrence of cracks. The joining layer can be formed by using a joining material. The joining material is not particularly limited, but may be a ceramic material with a solvent such as water added to make a paste. The joining material may contain the same material as the partition walls. In addition to joining the honeycomb segments together, the joining material can also be used as an outer periphery coating material after the honeycomb segments are joined.

### 2. Manufacturing Method

A method for manufacturing a pillar-shaped honeycomb structure according to one embodiment of the present invention will be described below by way of example. First, a raw material composition containing a cordierite-forming raw material, a pore-forming material, a dispersion medium, and a binder is kneaded to form a green body, and then the green body is extrusion molded to obtain a pillar-shaped honeycomb formed body having an outer peripheral side wall, and a plurality of cells on the inner peripheral side of the outer peripheral side wall, extending from an inlet end surface to an outlet end surface, in which the inlet end surface and the outlet end surface both have openings. The raw material composition may contain additives such as a dispersant or other ceramic raw materials as necessary. In the extrusion molding, a die having a desired overall shape, cell shape, cell arrangement, partition wall thickness, cell density, and the like can be used.

The cordierite-forming raw material is a raw material that becomes cordierite when fired, and can be provided, for example, in the form of a powder. The cordierite raw material desirably has a chemical composition of 30 to 45% by mass of alumina (Al₂O₃) (including aluminum hydroxide that converts to alumina), 11 to 17% by mass of magnesia (MgO), and 42 to 57% by mass of silica (SiO₂).

The dispersion medium may be water or a mixed solvent of water and an organic solvent such as alcohol, and water is particularly preferred.

The content of the dispersion medium in the honeycomb formed body before the drying process is preferably 20 to 110 parts by mass, more preferably 25 to 100 parts by mass, and even more preferably 30 to 90 parts by mass, with respect to 100 parts by mass of the cordierite-forming raw material. When the content of the dispersion medium in the honeycomb formed body is 20 parts by mass or more with respect to 100 parts by mass of the cordierite-forming raw material, the quality of the honeycomb structure is likely to be stable. When the content of the dispersion medium in the honeycomb formed body is 90 parts by mass or less with respect to 100 parts by mass of the cordierite-forming raw material, the amount of shrinkage during drying is small, and deformation can be suppressed. In this specification, the content of the dispersion medium in the honeycomb formed body refers to a value measured by a loss on drying method.

The pore-forming material is not particularly limited as long as it becomes pores after firing, and examples thereof include wheat flour, starch, foamed resin, water-absorbent resin, silica gel, carbon (for example, graphite), ceramic balloons, polyethylene, polystyrene, polypropylene, nylon, polyester, acrylic resin, and phenol. As the pore-forming material, one type may be contained alone, and two or more types may be contained in combination. From the viewpoint of increasing the porosity of the honeycomb structure after firing, the content of the pore-forming material is preferably 3 parts by mass or more, more preferably 6 parts by mass or more, and even more preferably 9 parts by mass or more, with respect to 100 parts by mass of the cordierite-forming raw material. From the viewpoint of ensuring the strength of the honeycomb structure after firing, the content of the pore-forming material is preferably 30 parts by mass or less, more preferably 27 parts by mass or less, and even more preferably 24 parts by mass or less, with respect to 100 parts by mass of the cordierite-forming raw material.

As the binder, examples thereof include methyl cellulose, hydroxypropoxyl methyl cellulose, hydroxypropyl methyl cellulose, hydroxyethyl cellulose, hydroxyethyl methyl cellulose, carboxymethyl cellulose, and polyvinyl alcohol. In addition, from the viewpoint of increasing the strength of the honeycomb formed body before firing, the content of the binder is preferably 4 parts by mass or more, more preferably 4.5 parts by mass or more, and even more preferably 5 parts by mass or more, with respect to 100 parts by mass of the cordierite-forming raw material. From the viewpoint of suppressing cracks due to abnormal heat generation during the firing process, the content of the binder is preferably 9 parts by mass or less, more preferably 8 parts by mass or less, and even more preferably 7 parts by mass or less, with respect to 100 parts by mass of the cordierite-forming raw material. As the binder, one type may be contained alone, and two or more types may be contained in combination.

As the dispersant, ethylene glycol, dextrin, fatty acid soap, polyether polyol, and the like can be used. As the dispersant, one type may be used alone, and two or more types may be used in combination. The content of the dispersant in the green body is preferably 0 to 2 parts by mass with respect to 100 parts by mass of the cordierite-forming raw material.

For drying of honeycomb formed body, conventionally known drying methods such as hot gas drying, microwave drying, dielectric drying, reduced pressure drying, vacuum drying, and freeze drying can be used. Among these, a drying method that combines hot gas drying with microwave drying or dielectric drying is preferable since the entire honeycomb formed body can be dried quickly and uniformly.

After drying the honeycomb formed body, sealing portions are formed on both end surfaces of the honeycomb formed body. Each sealing portion can be formed by filling the openings of the inlet cells and the outlet cells where the sealing portions are to be formed with a sealing portion forming slurry, and then drying and firing the filled slurry. The sealing portion forming slurry can be made of the material of the honeycomb formed body. For example, without being limited thereto, when the honeycomb formed body contains a cordierite-forming raw material, a pore forming material, a dispersion medium, and a binder, the sealing portion forming slurry can contain the cordierite-forming raw material, the pore forming material, the dispersion medium, and the binder.

For example, the sealing portion forming slurry contains 30 to 60 parts by mass of the dispersion medium, 5 to 20 parts by mass of the pore-forming material, and 0.2 to 2.0 parts by mass of the binder, with respect to 100 parts by mass of the cordierite-forming raw material. In a preferred embodiment, the sealing portion forming slurry contains 35 to 50 parts by mass of the dispersion medium, 8 to 16 parts by mass of the pore-forming material, and 0.2 to 1.5 parts by mass of the binder, with respect to 100 parts by mass of the cordierite-forming raw material.

The dispersion medium may be water or a mixed solvent of water and an organic solvent such as alcohol, and water is particularly preferred.

The pore-forming material is not particularly limited as long as it becomes pores after firing, and examples thereof include wheat flour, starch, foamed resin, water-absorbent resin, silica gel, carbon (for example, graphite), ceramic balloons, polyethylene, polystyrene, polypropylene, nylon, polyester, acrylic resin, phenol, and the like. As the pore-forming material, one type may be used alone, or two or more types may be used in combination.

As the binder, examples include organic binders such as methyl cellulose, hydroxypropoxyl methyl cellulose, hydroxypropyl methyl cellulose, hydroxyethyl cellulose, hydroxyethyl methyl cellulose, carboxymethyl cellulose, and polyvinyl alcohol. As the binder, one type may be used alone, and two or more types may be used in combination.

The sealing portion forming slurry may contain a dispersant as appropriate. Examples of the dispersant include ethylene glycol, dextrin, fatty acid soap, polyalcohol, and the like. As the dispersant, one type may be used alone, and two or more types may be used in combination.

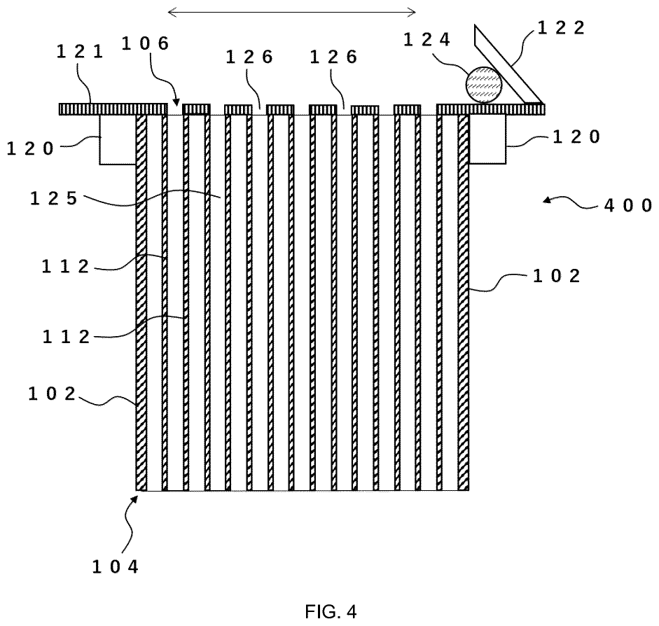

The openings of the cells can be filled with the sealing portion forming slurry by, for example, the following “squeegee method.” As shown in FIG. 4, a film 121 is attached to the upper end surface (here, the outlet end surface 106 in the figure) of the dried honeycomb formed body 400 fixed by a chuck 120, and a laser is irradiated onto the film 121 at positions corresponding to the arrangement conditions of the sealing portions, thereby drilling a plurality of holes 126 in the film 121.

Thereafter, a sealing portion forming slurry 124 is placed on the film 121, and a squeegee 122 is moved along the film 121 in the direction of the arrow in FIG. 4. As a result, a certain amount of sealing portion forming slurry 124 is filled into cells 125 that are open at positions corresponding to the holes 126 of the film 121.

The depth of the sealing portion can be changed by the number of times the squeegee 122 is moved, the contact angle between the squeegee 122 and the film 121, the pressing pressure of the squeegee 122 against the film 121, and the viscosity of the sealing portion forming slurry 124, and the like.

After filling with the sealing portion forming slurry 124, the film 121 is peeled off and the entire honeycomb formed body 400 is dried. Through this drying process, the sealing portion forming slurry 124 filled in the cells 125 is dried, and the sealing portions before firing are formed. Drying can be carried out, for example, at a drying temperature of 100 to 230° C. for about 60 to 150 seconds. After drying, the sealing portions protruding from the end surfaces of the honeycomb formed body by the thickness of the film, and can be scraped off as necessary.

The material of the film is not particularly limited, but is preferably polypropylene (PP), polyethylene terephthalate (PET), polyimide, or Teflon (registered trademark), since these materials are easily heat-processed to form holes. The film preferably has an adhesive layer, and the material of the adhesive layer is preferably an acrylic resin, a rubber-based material (for example, a rubber whose main component is natural rubber or synthetic rubber), or a silicone-based resin. The film may be, for example, an adhesive film having a thickness of 20 to 50 μm.

Besides the above-mentioned “squeegee method”, another method for filling the openings of the cells with the sealing portion forming slurry is the “pressure-in method.” The “press-in method” is a method in which an end surface of a honeycomb formed body with a film attached and holes drilled therein is immersed in a liquid tank containing a sealing portion forming slurry, and the cells are filled with the sealing portion forming slurry. In this case, the depth of the sealing portions can be changed by changing the depth to which the honeycomb formed body is immersed in the sealing portion forming slurry.

The honeycomb formed body filled with the sealing portion forming slurry is then subjected to a degreasing process and a firing process, thereby manufacturing a honeycomb structure. The combustion temperature of the binder is about 200° C., and the combustion temperature of the pore-forming material is about 300 to 1000° C. Therefore, the degreasing step may be carried out by heating the honeycomb formed body to a range of about 200 to 1000° C. The heating time is not particularly limited, but is usually about 10 to 100 hours. The honeycomb formed body after the degreasing process is called a calcined body. The firing process depends on the material composition of the honeycomb structure, but can be carried out, for example, by heating the calcined body to 1300 to 1450° C. and holding it for 3 to 24 hours.

A catalyst can be carried on the partition walls of the honeycomb structure manufactured as described above. One example of a method for carrying a catalyst on the partition walls includes introducing a catalyst slurry into the cells by a conventionally known suction method or the like for allowing it to adhere to the surfaces and pores of the partition walls, and then subjecting it to high-temperature treatment to bake the catalyst contained in the catalyst slurry onto the partition walls. The types of catalyst are as exemplified above.

### EXAMPLES

Hereinafter, Examples are provided to better understand the present invention and its advantages, but the present invention is not limited to these Examples.

### 1. Manufacturing of Honeycomb Structure

### [Honeycomb Structure Made of Cordierite: Examples 1 to 21, Comparative Examples 1 to 9]

5 parts by mass of a pore-forming material, 60 parts by mass of a dispersion medium, and 4 parts by mass of an organic binder were added to 100 parts by mass of the cordierite-forming raw material, and they were mixed and kneaded to prepare a green body. The cordierite-forming raw material used was alumina, aluminum hydroxide, kaolin, talc, and silica. Water was used as the dispersion medium, and methylcellulose was used as the organic binder. As the pore-forming material, a water-absorbent resin having a median diameter of 20 μm was used. In the Examples, the median diameter of the raw material is the particle diameter at 50% of the integrated value (D50) in the particle size distribution obtained by a laser diffraction/scattering method.

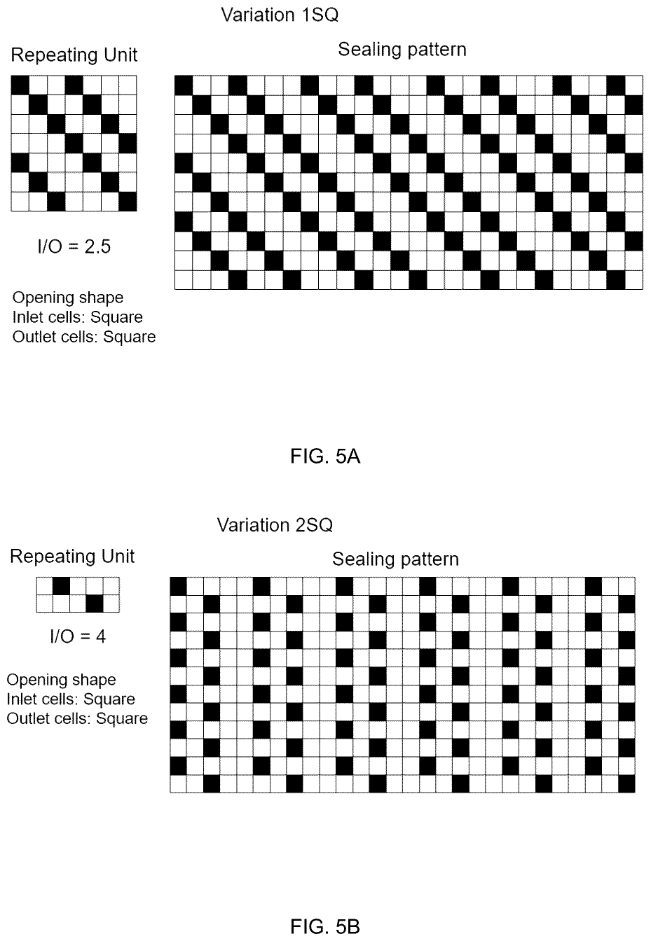

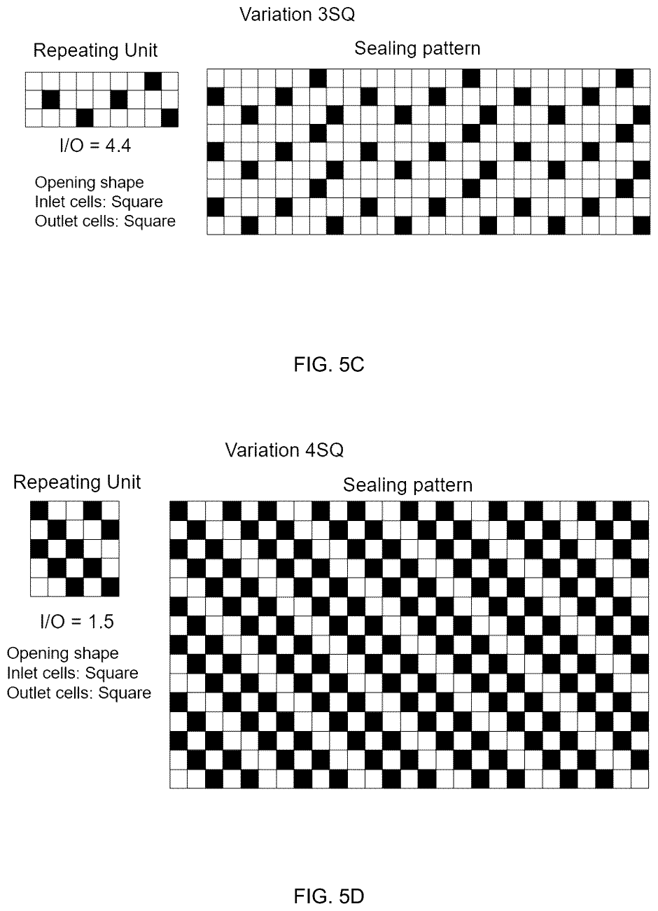

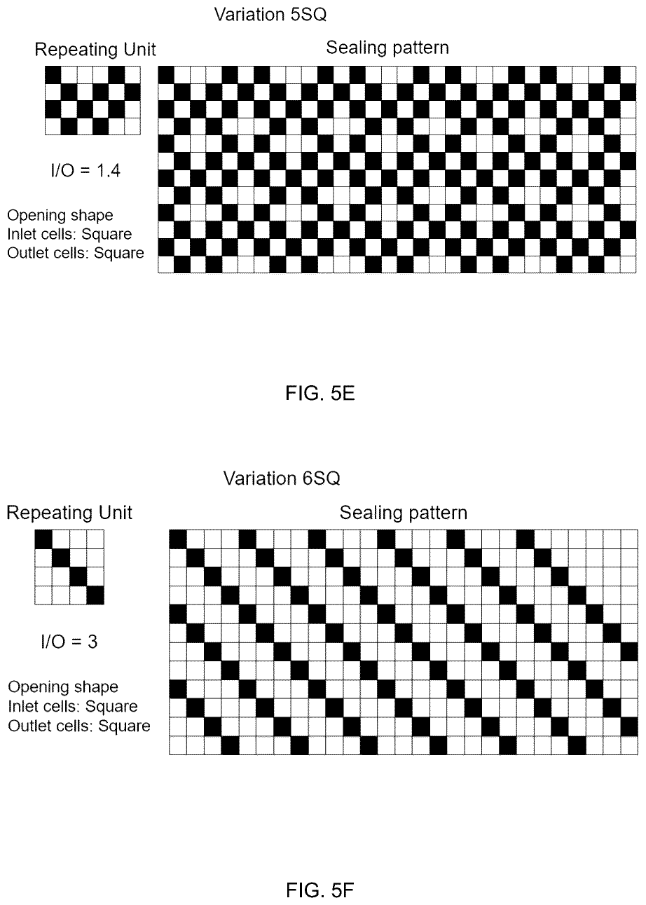

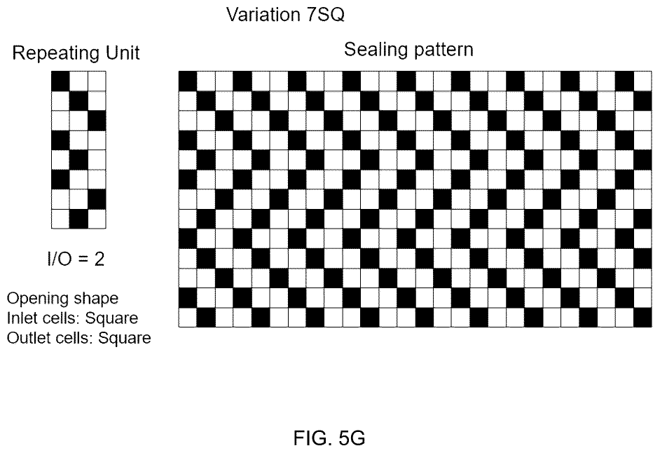

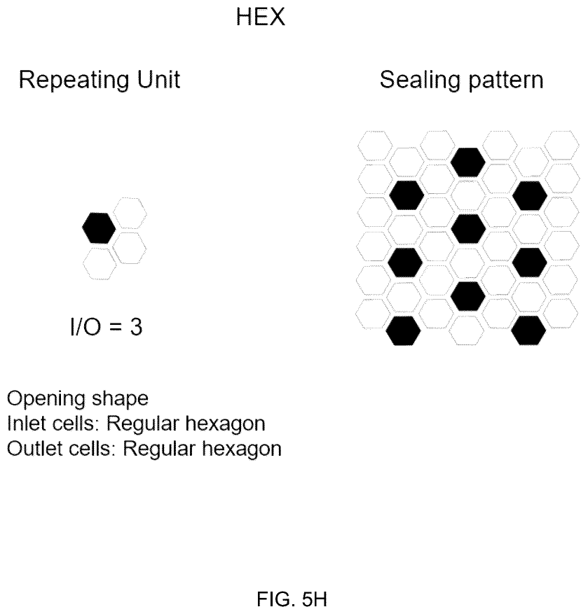

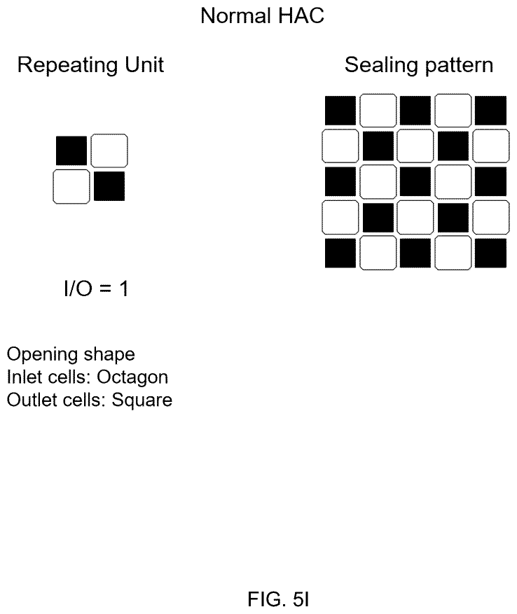

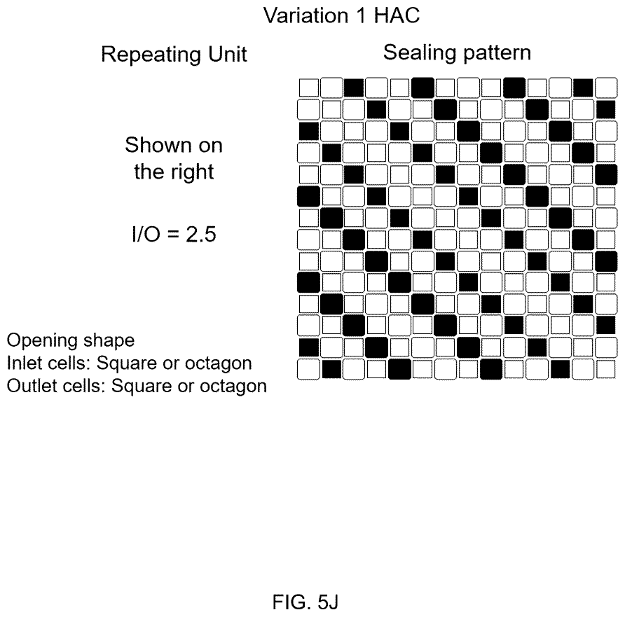

Next, the green body was extrusion molded using a die for producing a honeycomb formed body, thereby obtaining a honeycomb formed body having an overall cylindrical shape. The cell structure of the honeycomb formed body was in accordance with the “Cell structure and sealing pattern” shown in Table 1 according to the test numbers. The specific cell structures described in “Cell Structure and sealing Pattern” are illustrated in FIGS. 5A to 5J. FIGS. 5A to 5J are schematic diagrams showing the opening shapes of a plurality of inlet cells and a plurality of outlet cells, the sealing pattern, and the repeating units constituting the sealing pattern observed at the inlet end surface. The white cells represent the inlet cells, and the black cells represent the outlet cells. At this stage, sealing portions were not formed, but sealing portions for the outlet cells would be formed at the inlet end surfaces. I/O in the figures represents the ratio of the number of inlet cells to the number of outlet cells.

In each of FIGS. 5A-5H, the opening shapes and opening areas of the inlet cells and outlet cells are all the same except for those adjacent to the outer peripheral side wall.

In FIG. 5I, the opening shapes and opening areas of each of the inlet cells are all the same except for those adjacent to the other peripheral side wall. The opening shapes and opening areas of each of the outlet cells are all the same except for those adjacent to the outer peripheral side wall.

In FIG. 5J, the opening shapes and opening areas of each of the inlet cells and the outlet cells having a square shape are all the same except for those adjacent to the outer peripheral side wall. The opening shapes and opening areas of each of the inlet cells and the outlet cells having an octagon shape are all the same except for those adjacent to the outer peripheral side wall.

Next, the honeycomb formed body was dried in a microwave dryer and further dried in a hot gas dryer, after which both end surfaces of the honeycomb formed body were cut to a predetermined size.

Next, a sealing portion forming slurry was prepared using the same material as that of the honeycomb formed body. Thereafter, using this slurry, sealing portions were formed at the openings of the predetermined cells on the inlet end surface side and at the openings of the remaining cells on the outlet end surface side of the dried honeycomb formed body. The sealing portions were formed so as to obtain the “Cell structure and sealing pattern” in Table 1 according to the test numbers.

Next, each of the honeycomb formed bodies after forming sealing portions was degreased at about 200 to 1000° C. in the air atmosphere, and further fired at about 1410 to 1440° C. in the air atmosphere to produce a honeycomb structure corresponding to each test number. The honeycomb structure thus obtained had a cylindrical shape with circular inlet end surface and outlet end surface. The diameters of the inlet end surface and the outlet end surface were 330 mm. The length of the honeycomb structure in the cell extension direction was 178 mm. A required number of the honeycomb structures necessary to specify the following specifications and properties were prepared.

### [Silicon Carbide Honeycomb Structure: Example 22, Comparative Example 10]

SiC powder and Si powder were mixed in a mass ratio of SiC powder: Si powder=80:20, and 3 parts by mass of a pore-forming material and 7 parts by mass of an organic binder were added to 100 parts by mass of this mixture, and a dispersion medium was further added, and they were mixed and kneaded to prepare a green body. Water was used as the dispersion medium, methylcellulose was used as the organic binder, and a water-absorbent polymer with a median diameter of 20 μm was used as the pore-forming material.

Next, the green body was extrusion molded using a die for preparing a honeycomb formed body to obtain a honeycomb formed body having an overall shape of a rectangular parallelepiped. The cell structure of the honeycomb formed body was in accordance with the “Cell structure and plugging pattern” described in Table 1 according to the test numbers.

Next, the honeycomb formed body was dried in a microwave dryer and further dried in a hot gas dryer, after which both end faces of the honeycomb formed body were cut to a predetermined size.

Next, a sealing portion forming slurry was prepared using the same material as the honeycomb formed body. After that, using this slurry, sealing portions were formed at the openings of the predetermined cells on the inlet end surface side and at the openings of the remaining cells on the outlet end surface side of the dried honeycomb formed body. The sealing portions were formed so as to obtain the “Cell structure and plugging pattern” in Table 1 according to the test numbers.

Next, the honeycomb formed body with the sealing portions formed therein was degreased at about 400° C. in an air atmosphere, and further fired at about 1450° C. in an Ar inert atmosphere to manufacture a honeycomb segment. The honeycomb segment thus obtained had a rectangular parallelepiped shape with the inlet end surface and the outlet end surface being square. The size of one side of the inlet end surface and the outlet end surface was 42 mm. The length of the honeycomb segment in the direction in which the cells extend was 178 mm. A plurality of identical honeycomb segments were prepared, and joining material was sandwiched between the outer surfaces of these segments, such that a segment stack was prepared composed of a total of 60 honeycomb segments, assembled in an 8×8 matrix (however, the four segments at the corners were not required). Then, the entire stack was joined by applying external pressure as appropriate, and then dried at 120° C. for two hours to obtain a segment joined body. The outer periphery of this segment joined body was ground such that the outer shape was cylindrical, and then a coating material with the same composition as the joining material was applied to the ground surface to re-form the outer periphery side wall. The honeycomb structure for each test example was then dried and hardened in the air at 700° C. for two hours. The honeycomb structure thus obtained had a cylindrical shape with circular inlet and outlet end surfaces. The diameters of the inlet end surface and the outlet end surface were 330 mm. The length of the honeycomb structure in the direction in which the cells extend was 178 mm. A required number of the honeycomb structures necessary to specify the following specifications and properties were prepared.

### 2. Specifications of Honeycomb Structure

For the honeycomb structures of each test number manufactured above, the partition wall thickness (constant value), cell density, length of one side of the cell opening, offset when there are two types of cell openings (large and small), S₂/S₁, ratio of inlet cells that are not adjacent to outlet cells, ratio of outlet cells adjacent only to inlet cells, opening ratio of the inlet end surface, average linear expansion coefficient, average porosity of the partition walls, and I/O are shown in Table 1.

The thickness of the partition walls was measured by observation with a scanning electron microscope (SEM).

The cell density means the cell density based on the total number of inlet cells and outlet cells, and was measured according to the method described above.

The length of one side of the cell opening was measured by observation with a scanning electron microscope (SEM). When the cell opening had a single type of square or regular hexagon, the length of one side of that square or regular hexagon was shown. When there were two types of cell openings, a large octagon and a small square, both the length of the shorter side that is the distance between a pair of opposing sides of the octagon of the large cell opening and the length of one side of the square of the small cell opening were shown.

The offset represents the distance between the midpoint of a line segment connecting the centers of gravity of adjacent inlet cells and outlet cells across a partition wall, and the center of the partition wall that the line segment crosses in a cross-section perpendicular to the direction in which the plurality of inlet cells and plurality of outlet cells extend. The offset was measured by observation with a scanning electron microscope (SEM).

S₁ represents the total surface area of all the partition walls partitioning the plurality of inlet cells except for the inlet cells adjacent to the outer peripheral side wall, and was calculated using scanning electron microscope (SEM) observation.

S₂ represents the total surface area of all the partition walls sandwiched between adjacent inlet cells among the plurality inlet cells except for the inlet cells adjacent to the outer peripheral side wall, and was calculated using scanning electron microscope (SEM) observation.

The average linear expansion coefficient represents the average linear expansion coefficient of the partition walls from room temperature to 800° C. in the direction in which the inlet cells and outlet cells extend, and was measured by taking a sample of the partition walls and following the method described above.

The average porosity of the partition walls was measured by the mercury porosimetry method as described above-mentioned using Autopore 9500 (product name) manufactured by Micromeritics Instrument Corporation.

### 3. Properties of Honeycomb Structure

The honeycomb structures having the respective test numbers prepared above were used as exhaust gas filters, and the following characteristics were evaluated.

### [Ash Accumulation]

A filter with a diameter of 330 mm and a length of 178 mm was weighed in advance and then installed in the exhaust system of a 13-liter diesel engine. Ash was allowed to accumulate by repeating the WHTC cycle (World Harmonized Transient Cycle: see global technical regulation No. 4: TRANS/WP (unece.org)). The pressure loss was measured every 10 hours at the inlet of the filter at a flow rate of 1,800 kg/hr and a temperature of 380° C. When the pressure loss reached 25 kPa, the filter was subjected to a heat treatment at 600° C. for 3 hours or more in an electric furnace to burn off the soot, and the weight of the filter and the pressure loss under the above flow rate and temperature conditions were then measured again. Furthermore, the WHTC cycle, the heat treatment and weight measurement every 5 hours, and the pressure loss measurement under the above flow rate and temperature conditions were repeated until the pressure loss after burning off the soot reached 25 kPa. The weight difference between before and after the test was calculated, and the calculated value was divided by the volume of the filter to determine the ash accumulation weight (g) per volume (L) based on the external dimensions of the filter when the pressure loss after burning off the soot reached 25 kPa (hereinafter referred to as “ash accumulation”).

In Comparative Example 1, which stands for a conventional technology, the ash accumulation was 40 g/L. Therefore, the evaluation of the ash accumulation was based on the following criteria. When the pressure loss reached 25 kPa, if the ash accumulation was less than 40 g/L, the score was 0. If the ash accumulation was 40 g/L or more, the score was the increase rate relative to 40 g/L multiplied by 1.0. The results are shown in Table 1.

### [Pressure Loss Gradient Upon PM Accumulation]

A filter with a diameter of 330 mm and a length of 178 mm was installed in the exhaust system of a diesel engine with a displacement of 13 liters, and soot was allowed to accumulate on the filter. In addition, during the soot accumulation, the fuel injection pressure was lowered to facilitate soot generation, and the engine was operated under low-temperature conditions with the exhaust gas temperature at the inlet of the filter kept below 280° C. to prevent the soot from burning. Pressure loss was measured at intervals of approximately 1 g/L as the amount of soot accumulated in the filter increased from approximately 1 g/L to 6 g/L. When measuring the pressure loss, the engine output was increased and the pressure on the inlet and outlet sides and the weight of the filter were measured at a flow rate of 1,800 kg/hr and a temperature of 380° C. at the filter inlet, and the pressure loss for each soot amount was calculated. Next, a graph was created with the soot weight per volume (g/L) based on the external dimensions of the filter on the x-axis and the pressure loss (kPa) on the y-axis, and an approximation line was drawn using the least squares method. Finally, the gradient of the pressure loss when PM was accumulated from 1 g/L to 6 g/L (the increase in pressure loss in kPa for every 1 g/L of soot accumulation) was determined.

In Comparative Example 1, which stands for a conventional technology, the gradient of pressure loss when PM was accumulated from 1 g/L to 6 g/L (hereinafter referred to as “pressure loss gradient”) was 1.0 kPa. Therefore, the evaluation of the pressure loss gradient was based on the following criteria: A pressure loss gradient of less than 0.9 kPa was given a score of 0. A pressure loss gradient of 0.9 kPa to 1.1 kPa was considered to be at the same level as conventional technology and given a score of 1, and a pressure loss gradient of more than 1.1 kPa was given a score of the increase rate relative to 1.0 kPa multiplied by 1.0. The results are shown in Table 1.

### [Crack Limit]

A filter having a diameter of 330 mm and a length of 178 mm was installed in the exhaust system of a diesel engine having a displacement of 13 liters, and soot was allowed to accumulate on the filter. In addition, during the soot accumulation, the fuel injection pressure was lowered to facilitate soot generation, and the engine was operated under low-temperature conditions, with the exhaust gas temperature at the filter inlet kept below 280° C., to prevent the soot from burning. Next, at the inlet of the filter, the exhaust gas temperature was increased to 650° C. at a rate of 4° C./sec with a flow rate of 600 kg/hr. The conditions were then changed to idling, and the gas flow rate at the filter inlet was rapidly reduced to 150 kg/hr, while fuel injection was performed to regenerate the filter. After the filter was regenerated, the filter was visually checked for any cracks, and if no cracks were found, the weight of soot accumulated inside the filter was increased and the filter regeneration test was repeated. The weight of soot in the filter was gradually increased each time the test was repeated. The maximum weight of soot that did not cause cracks in the filter was then investigated. The maximum weight of soot per volume (g/L) at this time based on the outer dimensions of the filter was defined as the “crack limit.”

A crack limit that does not cause problems in practical use is 5 g/L. Therefore, the crack limit was evaluated based on the following criteria. If the crack limit was less than 5 g/L, a score was 0. If the crack limit was 5 g/L or more, a score was 1.0. The results are shown in Table 1.

### [Comprehensive Evaluation]

The overall evaluation was calculated by multiplying the scores obtained from the above three items. The results are shown in Table 1.

Comparative Example 1, which stands for a conventional technology, received a score of 1.0 for each evaluation item, and the overall evaluation was also 1.0. In contrast, in Comparative Examples 2 to 10, which received an overall score of 0, at least one of the ash accumulation, the pressure loss gradient upon PM accumulation, and the crack limit was significantly reduced compared to the existing technology. If the ash accumulation is reduced, the frequency of filter regeneration and cleaning treatment increases. If the pressure loss gradient upon PM accumulation decreases, the soot detection accuracy of the pressure sensor may be impaired, and further, if the crack limit decreases, the filter may be damaged during actual use, causing a malfunction. Therefore, Comparative Examples 2 to 10 are inappropriate.

Examples 1 to 22 exceeded the existing technology in at least one of the ash accumulation and the pressure loss gradient upon PM accumulation, and also passed the evaluation of the crack limit, so that they also exceeded the existing technology in the overall evaluation.

In Examples 2, 4, 6 to 8, 10 to 11, 14 to 18, and 20 to 22, the ash accumulation was greater than that of the existing technology, and the pressure loss gradient upon PM accumulation was also greater than that of the existing technology. This provides a special effect of improving the soot detection accuracy of the pressure sensor while reducing the frequency of filter regeneration and cleaning treatment.

TABLE 1

| | | | | | | | | | Ratio |
|---|---|---|---|---|---|---|---|---|---|
| | | | | | | | | Ratio | of outlet |
| | | | | Length | Length | | | of inlet | cells |
| | | | | of one | of one | | | cells not | adjacent |
| | Cell | Partition | Cell | side of | side of | | | adjacent | to only |
| | structure | wall | density | cell (or | small | | | to outlet | inlet |
| | and sealing | thickness | [cells/ | large cell) | cell | Offset | S₂/S₁ | cells | cells |
| | pattern | [mm] | cm²] | [mm] | [mm] | [mm] | [%] | [%] | [%] |
| Comparative | Normal HAC | 0.22 | 47 | 1.41 | 1.09 | 0.08 | 10% | 6% | 100% |
| Example 1 | | | | | | | | | |
| Comparative | Normal HAC | 0.19 | 62 | 1.28 | 0.88 | 0.10 | 17% | 0% | 100% |
| Example 2 | | | | | | | | | |
| Comparative | Normal HAC | 0.26 | 31 | 1.65 | 1.41 | 0.06 | 4% | 0% | 100% |
| Example 3 | | | | | | | | | |
| Comparative | Veriation 5SQ | 0.25 | 31 | 1.54 | — | — | 29% | 14% | 100% |
| Example 4 | | | | | | | | | |
| Example 1 | Variation 4SQ | 0.25 | 31 | 1.54 | — | — | 33% | 09% | 100% |
| Example 2 | Variation 1SQ | 0.25 | 31 | 1.54 | — | — | 60% | 20% | 100% |
| Example 3 | Variation 2SQ | 0.25 | 31 | 1.54 | — | — | 75% | 25% | 100% |
| Comparative | Variation 3SQ | 0.25 | 31 | 1.54 | — | — | 77% | 18% | 100% |
| Example 5 | | | | | | | | | |
| Example 4 | Variation 1HAC | 0.26 | 31 | 1.65 | 1.41 | 0.06 | 60% | 20% | 50% |
| Example 5 | HEX | 0.27 | 31 | 1.52 | — | — | 33% | 0% | 100% |
| Comparative | Variation 1SQ | 0.14 | 31 | 1.66 | — | — | 60% | 20% | 100% |
| Example 6 | | | | | | | | | |
| Example 6 | Variation 1SQ | 0.15 | 31 | 1.64 | — | — | 60% | 20% | 100% |
| Example 7 | Variation 1SQ | 0.18 | 31 | 1.62 | — | — | 60% | 20% | 100% |
| Example 8 | Variation 1SQ | 0.30 | 31 | 1.49 | — | — | 60% | 20% | 100% |
| Example 9 | Variation 1SQ | 0.38 | 31 | 1.42 | — | — | 60% | 20% | 100% |
| Comparative | Veriation 1SQ | 0.40 | 31 | 1.40 | — | — | 60% | 20% | 100% |
| Example 7 | | | | | | | | | |
| Comparative | Variation 1SQ | 0.25 | 19 | 2.06 | — | — | 60% | 20% | 100% |
| Example 8 | | | | | | | | | |
| Example 10 | Variation 1SQ | 0.25 | 22 | 1.89 | — | — | 60% | 20% | 100% |
| Example 11 | Veriation 1SQ | 0.25 | 25 | 1.69 | — | — | 60% | 20% | 100% |
| Example 12 | Variation 1SQ | 0.25 | 62 | 1.02 | — | — | 60% | 20% | 100% |
| Example 13 | Variation 1SQ | 0.25 | 70 | 0.94 | — | — | 60% | 20% | 100% |
| Comparative | Veriation 1SQ | 0.25 | 75 | 0.90 | — | — | 60% | 20% | 100% |
| Example 9 | | | | | | | | | |
| Example 14 | Variation 2SQ | 0.30 | 28 | 1.59 | — | — | 75% | 25% | 100% |
| Example 15 | Variation 2SQ | 0.23 | 43 | 1.29 | — | — | 75% | 25% | 100% |
| Example 16 | Variation 6SQ | 0.30 | 28 | 1.59 | — | — | 67% | 33% | 100% |
| Example 17 | Variation 6SQ | 0.23 | 43 | 1.29 | — | — | 67% | 33% | 100% |
| Example 18 | Veriation 7SQ | 0.21 | 47 | 1.26 | — | — | 50% | 0% | 100% |
| Example 19 | Variation 7SQ | 0.18 | 62 | 1.09 | — | — | 50% | 0% | 100% |
| Example 20 | Variation 4SQ | 0.21 | 47 | 1.26 | — | — | 33% | 0% | 100% |
| Example 21 | Variation 4SQ | 0.18 | 62 | 1.09 | — | — | 33% | 0% | 100% |
| Comparative | Normal HAC | 0.18 | 47 | 1.42 | 1.15 | 0.07 | 9% | 0% | 100% |
| Example 10 | | | | | | | | | |
| Example 22 | Variation 1SQ | 0.23 | 34 | 1.48 | — | — | 60% | 20% | 100% |

| | Inlet | Average | | | | | | |
|---|---|---|---|---|---|---|---|---|
| | end | linear | | | | Pressure | | |
| | surface | expansion | | | | loss | | |
| | opening | coefficient | Average | | | gradient | | |
| | ratio | [×10⁻⁶/ | porosity | | Ash | upon PM | Crack | Comprehensive |
| | [%] | deg. C.] | (%) | I/O | accumulation | accumulation | Limit | evaluation |
| Comparative | 46% | 0.6 | 52 | 1.0 | 1.0 | 1.0 | 1.0 | 1.0 |
| Example 1 | | | | | | | | |
| Comparative | 49% | 0.6 | 52 | 1.0 | 1.3 | 0.0 | 1.0 | 0.0 |
| Example 2 | | | | | | | | |
| Comparative | 42% | 0.7 | 52 | 1.0 | 0.0 | 1.2 | 1.0 | 0.0 |
| Example 3 | | | | | | | | |
| Comparative | 43% | 0.5 | 52 | 1.4 | 0.0 | 1.3 | 1.0 | 0.0 |
| Example 4 | | | | | | | | |
| Example 1 | 44% | 0.7 | 52 | 1.5 | 1.0 | 1.3 | 1.0 | 1.3 |
| Example 2 | 53% | 0.6 | 52 | 2.5 | 1.4 | 1.1 | 1.0 | 1.6 |
| Example 3 | 59% | 0.6 | 52 | 4.0 | 1.6 | 1.0 | 1.0 | 1.6 |
| Comparative | 60% | 0.5 | 52 | 4.4 | 1.6 | 0.0 | 1.0 | 0.0 |
| Example 5 | | | | | | | | |
| Example 4 | 52% | 0.6 | 52 | 2.5 | 1.4 | 1.1 | 1.0 | 1.5 |
| Example 5 | 65% | 0.6 | 52 | 2.0 | 1.6 | 1.0 | 1.0 | 1.6 |
| Comparative | 61% | 0.5 | 52 | 2.5 | 1.6 | 1.1 | 0.0 | 0.0 |
| Example 6 | | | | | | | | |
| Example 6 | 60% | 0.7 | 52 | 2.5 | 1.6 | 1.1 | 1.0 | 1.7 |
| Example 7 | 58% | 0.6 | 52 | 2.5 | 1.6 | | 1.0 | 1.7 |
| Example 8 | 49% | 0.6 | 52 | 2.5 | 1.2 | 1.2 | 1.0 | 1.5 |
| Example 9 | 44% | 0.7 | 52 | 2.5 | 1.0 | 1.2 | 1.0 | 1.2 |
| Comparative | 43% | 0.6 | 52 | 2.5 | 0.0 | 1.2 | 1.0 | 0.0 |
| Example 7 | | | | | | | | |
| Comparative | 57% | 0.7 | 52 | 2.5 | 1.6 | 1.3 | 0.0 | 0.0 |
| Example 8 | | | | | | | | |
| Example 10 | 56% | 0.6 | 52 | 2.5 | 1.5 | 1.3 | 1.0 | 1.9 |
| Example 11 | 54% | 0.6 | 52 | 2.5 | 1.4 | 1.2 | 1.0 | 1.8 |
| Example 12 | 46% | 0.5 | 52 | 2.5 | 1.3 | 1.0 | 1.0 | 1.3 |
| Example 13 | 44% | 0.5 | 52 | 2.5 | 1.1 | 1.0 | 1.0 | 1.1 |
| Comparative | 43% | 0.6 | 52 | 2.5 | 0.0 | 0.0 | 1.0 | 0.0 |
| Example 9 | | | | | | | | |
| Example 14 | 56% | 0.7 | 52 | 4.0 | 1.5 | 1.2 | 1.0 | 1.8 |
| Example 15 | 58% | 0.7 | 52 | 4.0 | 1.6 | 1.2 | 1.0 | 1.8 |
| Example 16 | 53% | 0.6 | 52 | 3.0 | 1.4 | 1.2 | 1.0 | 1.6 |
| Example 17 | 54% | 0.6 | 52 | 3.0 | 1.5 | 1.2 | 1.0 | 1.7 |
| Example 18 | 49% | 0.6 | 52 | 2.0 | 1.5 | 1.1 | 1.0 | 1.7 |
| Example 19 | 49% | 0.5 | 52 | 2.0 | 1.6 | 1.0 | 1.0 | 1.6 |
| Example 20 | 44% | 0.6 | 52 | 1.5 | 1.4 | 1.2 | 1.0 | 1.6 |
| Example 21 | 44% | 0.5 | 52 | 4.5 | 1.5 | 1.1 | 1.0 | 1.7 |
| Comparative | 47% | 5 | 41 | 1.0 | 0.0 | 1.0 | 1.0 | 0.0 |
| Example 10 | | | | | | | | |
| Example 22 | 54% | 5.1 | 41 | 2.5 | 1.4 | 1.2 | 1.0 | 1.7 |

### DESCRIPTION OF REFERENCE NUMERALS

100: Honeycomb structure
102: Outer peripheral side wall
104: Inlet end surface
106: Outlet end surface
107: Opening
108: Inlet cell
109: Sealing portion
110: Outlet cell
112: Partition wall
120: Chuck
121: Film
122: Squeegee
124: Sealing section forming slurry
125: Cell
126: Hole
400: Honeycomb formed body

1. A pillar-shaped honeycomb structure, comprising:
an outer peripheral side wall;
a plurality of inlet cells arranged on an inner peripheral side of the outer peripheral side wall, extending from an inlet end surface to an outlet end surface, having an opening at the inlet end surface, and having a sealing portion at the outlet end surface; and
a plurality of outlet cells arranged on the inner peripheral side of the outer peripheral side wall, extending from the inlet end surface to the outlet end surface, having a sealing portion at the inlet end surface, and having an opening at the outlet end surface;
wherein each of the plurality of inlet cells and the plurality of outlet cells is adjacent to at least one of the plurality of inlet cells and the plurality of outlet cells with each of partition walls interposed therebetween,
wherein a cell density based on a total number of the plurality of inlet cells and the plurality of outlet cells is 22 to 70 cells/cm²,
wherein a thickness of each of the partition walls is in a range of 0.15 mm or more and 0.38 mm or less,
wherein an opening ratio at the inlet end surface is 44% or more, and
wherein assuming a total surface area of all the partition walls partitioning the plurality of inlet cells excluding the inlet cells adjacent to the outer peripheral side wall is S₁, and a total surface area of all the partition walls sandwiched between adjacent inlet cells among the plurality of inlet cells excluding the inlet cells adjacent to the outer peripheral side wall is S₂, 33%≤S₂/S₁≤75% is satisfied.

2. The honeycomb structure according to claim 1, wherein an opening area of each of the plurality of inlet cells are all the same except for those adjacent to the outer peripheral side wall.

3. The honeycomb structure according to claim 1, wherein an opening area of each of the plurality of inlet cells and the plurality of outlet cells are all the same except for those adjacent to the outer peripheral side wall.

4. The honeycomb structure according to claim 1, wherein an opening shape of each of the plurality of inlet cells is square except for those adjacent to the outer peripheral side wall.

5. The honeycomb structure according to claim 1, wherein an opening shape of each of the plurality of inlet cells and the plurality of outlet cells is all square except for those adjacent to the outer peripheral side wall.

6. The honeycomb structure according to claim 1, wherein an opening shape and an opening area of each of the plurality of inlet cells are all the same except for the one adjacent to the outer peripheral side wall.

7. The honeycomb structure according to claim 4, wherein a length of one side of the square is 0.90 mm or more and 1.90 mm or less.

8. The honeycomb structure according to claim 5, wherein a length of one side of the square is 0.90 mm or more and 1.90 mm or less.

9. The honeycomb structure according to claim 1, wherein none of the plurality of outlet cells are adjacent to each other.

10. The honeycomb structure according to claim 1, wherein the partition walls have an average linear expansion coefficient from room temperature to 800° C. in a direction in which the inlet cells and the outlet cells extend of 1.0×10⁻⁶/° C. or less.

11. The honeycomb structure according to claim 1, wherein the partition walls comprise cordierite.

12. The honeycomb structure according to claim 1, wherein the thickness of each of the partition walls is in a range of 0.18 mm or more and 0.30 mm or less.

13. The honeycomb structure according to claim 1, wherein the cell density based on the total number of the plurality of inlet cells and the plurality of outlet cells is in a range of 26 to 62 cells/cm².

14. The honeycomb structure according to claim 1, wherein at least one of the plurality of inlet cells is not adjacent to any of the plurality of outlet cells.

15. The honeycomb structure according to claim 1, wherein at least one of the plurality of outlet cells is adjacent to only an inlet cell.

16. The honeycomb structure according to claim 1, wherein
a ratio of a number of the plurality of inlet cells to a number of the plurality of outlet cells is 1.5 to 2.0, and the cell density based on the total number of the plurality of inlet cells and the plurality of outlet cells is in a range of 47 to 62 cells/cm²; or
a ratio of a number of the plurality of inlet cells to the number of the plurality of outlet cells is 3.0 to 4.0, and the cell density based on the total number of the plurality of inlet cells and the plurality of outlet cells is in a range of 28 to 43 cells/cm².
